(19) United States
(12) Patent Application Publication
(10) Pub. No.: US 2007/0241231 A1
(43) Pub. Date: Oct. 18, 2007

(54) CABIN MODULE AND CABIN COMPARTMENT WITH SUCH A CABIN MODULE

(75) Inventors: Kathrin Meyer-Rusitschka, Marschacht (DE); Harry Kwik, Wentorf (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/734,070

(22) Filed: Apr. 11, 2007

Related U.S. Application Data
(60) Provisional application No. 60/744,762, filed on Apr. 13, 2006.

(30) Foreign Application Priority Data
Apr. 13, 2006 (DE) 10 2006 017 596.4

(51) Int. Cl. B64D 11/00

(52) U.S. Cl. 244/118.5

(57) ABSTRACT

A cabin module includes a pallet, onto which a component is pre-installed, wherein the pallet forms a floor element of a cabin compartment. Several cabin modules with pre-installed component, e.g. cabinet, table, wall, bed, seat, etc. may be combined amongst each other into a cabin compartment. Furthermore, power and water connections may be preinstalled onto the pallet.

### REFERENCE TO RELATED APPLICATIONS

This application claims the benefit of the filing date of U.S. Provisional Patent Application No. 60/744,762 filed Apr. 13, 2006, and of the German Patent Application No. 10 2006 017 596.4 filed Apr. 13, 2006, the disclosures of which are hereby incorporated herein by reference.

### FIELD OF THE INVENTION

The field relates to a cabin module and a cabin compartment, which is, for instance, formed by several such cabin modules, such as use in an aircraft.

### BACKGROUND OF THE INVENTION

A cabin compartment in an aircraft typically comprises several components, for instance seat, bed, locker, table, walls, and doors that are individually fastened to the floor of the airplane.

The built-in components afford very little flexibility as a rapid exchange or modification of the cabin compartment is very time consuming and difficult. Thus a changeover from the cabin compartment configuration to traditional First Class seating and vice versa is not a quick task.

### SUMMARY OF THE INVENTION

There may be a need to provide an option for modifying or reconfiguring a cabin compartment with minimal effort.

One solution to this problem includes providing a cabin module having a pallet that forms a cabin compartment floor element and in which one component is pre-installed.

According to another example of the cabin module, various connections, e.g. water or electric power connections may be pre-installed onto the pallet, wherein these connections may be coupled with corresponding connections of other pallets.

According to another example of the cabin module, at least one fastening element is provided on a bottom side of the pallet, which faces away from the side onto which a component is pre-installed, by means of which the pallet can be secured to a floor, on which the cabin compartment is to be formed.

In one example, the cabin module pallet is secured by means of a quick-release latch to a seat rail provided in the floor, on which the cabin compartment is to be formed. Other suitable fastening means may be used, wherein a force from the component that is pre-installed onto the pallet, is directly transmitted through the pallet onto the seat rail.

According to one example, the component for example, may be provided as a seat, locker, table, wall, door, or a combination of the previously named components.

According to an improvement of the cabin module, several cabin modules may be arbitrarily combined through their pallets in order to form a cabin compartment, wherein the sidewalls may be mounted onto outer pallets of several combined cabin modules amongst each other.

A cabin compartment according to one example, is comprised of several of the above mentioned cabin modules, which are preferably deployed in an aircraft.

According to one example, only few cabin modules with pre-installed components are required for the assembly of a cabin compartment, which provides for savings in time over the installation of individual components.

### BRIEF DESCRIPTION OF THE FIGURES

FIG. 1 shows a top view of a cabin compartment comprised of several cabin modules according to one example.

FIGS. 2a and 2b show perspective explosion views of another example.

Like reference numerals indicate the same components in these renderings.

### DETAILED DESCRIPTION

The examples described and drawings rendered are illustrative and are not to be read as limiting the scope of the invention as it is defined by the appended claims.

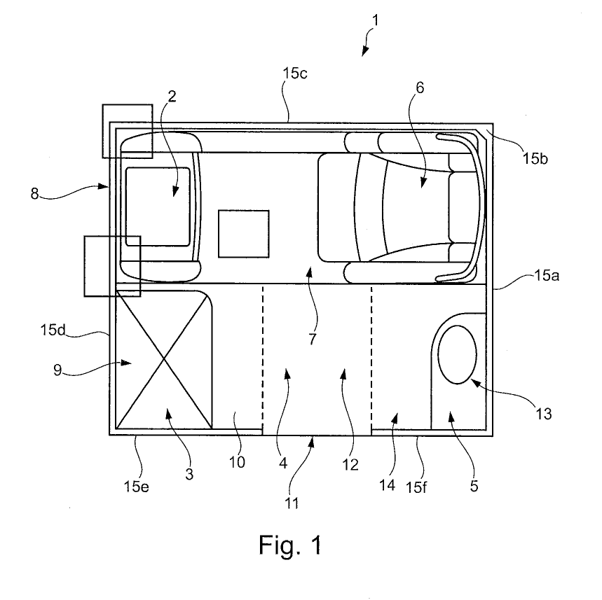

FIG. 1 depicts a top view of a cabin compartment 1 according to one example.

The cabin compartment 1 is comprised of four cabin modules 2, 3, 4, 5. Specifically, the cabin module 2 contains a sleeper seat 6, which is firmly mounted onto a pallet 7. The pallet 7 forms a part of the floor of the cabin compartment 1. The cabin module 2 also includes a window 8, which is pre-installed onto the pallet 7 according to one example.

According to one example, the cabin module 3 includes a locker 9 that is pre-installed onto a pallet 10, which forms a part of the floor of the cabin compartment 1.

According to one example, the cabin module 4 includes a door 11 with or without a window that is pre-installed on a pallet 12, which forms a part of the floor of cabin compartment 1.

According to one example, the cabin module 5 includes a sink 13 that is pre-installed on a pallet 14, which forms a part of the floor of the cabin compartment 1.

The cabin modules 2, 3, 4, and 5 with their respective components are separately preassembled prior to being integrated into a cabin compartment 1. The pallets 7, 10, 12, 14 of the individual cabin modules 2, 3, 4, 5 come into contact in their combined condition, for forming the overall floor of the cabin compartment 1. The individual cabin modules 2, 3, 4, and 5 are, for instance, fastened to seat rails (not shown) provided in the floor of an aircraft by means of a quick release fastener (not shown), an example of a fastening element.

As shown in FIG. 1, sidewall elements 15a through 15f of sidewall 15 are installed subsequent to the combination of the individual cabin modules 2, 3, 4, and 5 onto the respective pallets 7, 10, 12, and 14 of the respective cabin modules 2, 3, 4, 5 in order to provide for an enclosed cabin compartment 1.

The sidewalls 15 are preferably mounted to the respective pallets of the particular cabin modules 2, 3, 4, 5 only after the cabin modules 2, 3, 4, 5 have been combined in order to facilitate combining the cabin modules 2, 3, 4, 5 in a flexible manner.

Although the window 8 of the cabin module 2 is pre-installed according to the preferred embodiment, alternatively, the window 8 is fastened to the pallet 7 of the cabin module 2, subsequent to the individual cabin modules 2, 3, 4, 5 having been combined with the sidewalls 15.

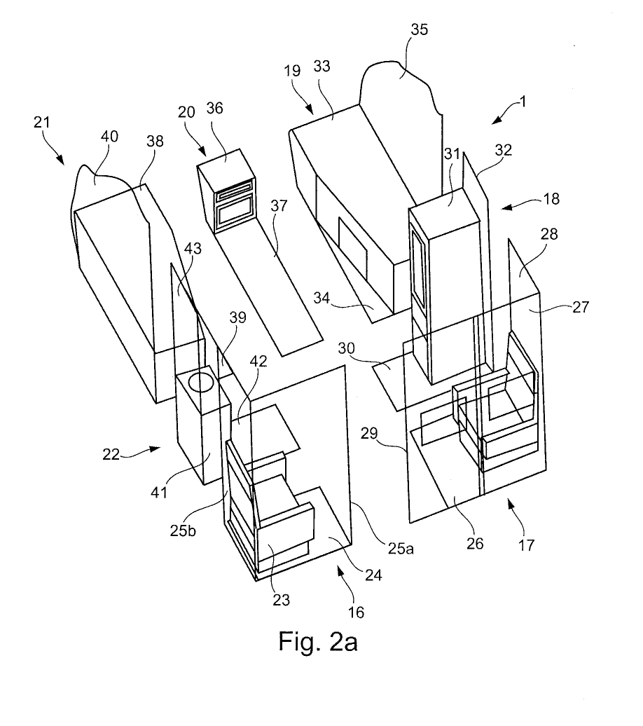

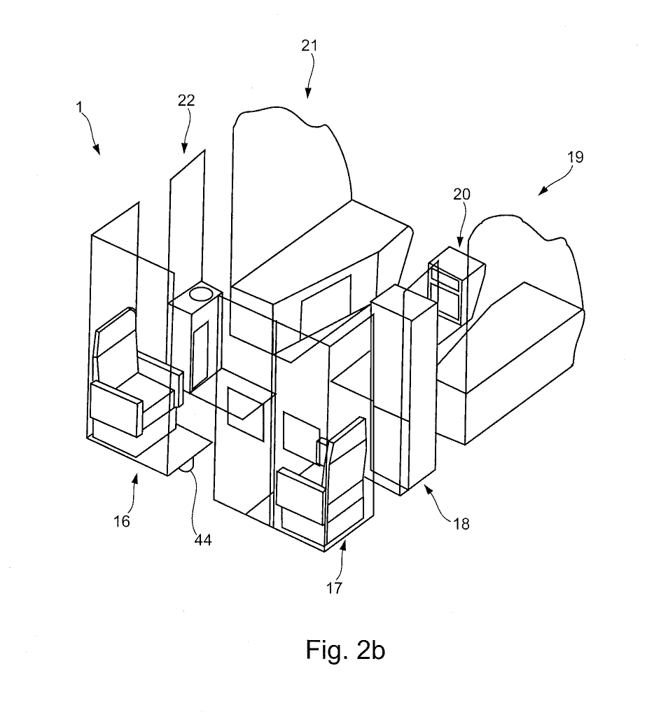

FIGS. 2a and 2b depict another example of a cabin compartment 1 from different perspectives.

The cabin module 1 shown in FIGS. 2a and 2b comprises seven cabin modules 16, 17, 18, 19, 20, 21, 22.

The cabin module 16 includes a seat 23 as a pre-installed component that is fastened onto a pallet 24. As depicted in FIG. 2a, sidewall elements 25a, b are mounted onto the surface of the pallet 24, onto which also the seat 23 is pre-installed. The sidewall 25a, b are preferably mounted onto the pallet 24 only subsequent to the combination of all cabin modules 16, 17, 18, 19, 20, 21, 22.

As depicted in FIG. 2a, the cabin module 17 also includes a seat 23 that is pre-installed onto a pallet 25. According to one example, the cabin module 17 further includes a wall panel 27 with a window, which is also pre-installed onto the pallet 26. Alternatively, the wall panel with window 27 may be subsequently installed onto the pallet 26 together with the sidewall 28 (once all cabin modules have been combined and fastened e.g. to the floor of an airplane), rather than being pre-installed.

As depicted in FIG. 2a, a door 29 with window is provided between the sidewall 25a of the cabin module 16 and the wall panel 27 of the cabin module 17. According to this embodiment, the door 29 with window together with the sidewalls is fastened subsequently onto the pallet 26 of the cabin module 17. Alternatively, a separate cabin module can be provided for the door 29 with window, wherein the door 29 with window is pre-installed onto a pallet.

The cabin module 18 includes a pallet 30, onto which a locker 31 is pre-installed. FIG. 2a furthermore shows a sidewall 32, which is subsequently fastened onto the pallet 30.

The cabin module 19 includes a bed 33, which is pre-installed onto a pallet 34. As shown in FIG. 2a, a sidewall 35 is subsequently mounted onto the pallet 34.

The cabin module 20 includes a nightstand 36 that is pre-installed onto a pallet 37.

The cabin module 21 includes a bed 38 that is pre-installed onto a pallet 39. As shown in FIG. 2a, a sidewall 40 is subsequently fastened onto the pallet 39 of the cabin module 21.

The cabin module 22 includes a sink 41 that is pre-installed on a pallet 42. As shown in FIG. 2a, a sidewall 43 is subsequently fastened onto the pallet 42 of the cabin module 22.

Upon combination of the individual cabin modules 16 through 22, the side surfaces of the respective pallets 24, 26, 30, 34, 37, 39, and 42 contact each other in such a manner that they form a uniform floor surface of the cabin compartment 1, wherein small seams show between the individual pallets.

Moreover, the respective sidewalls of the individual cabin modules are provided such that an enclosed cabin compartment 1 is provided upon combining of the individual cabin modules. In this example, one sidewall each in cabin modules 19, 20, and 21 is being omitted from FIG. 2a for purposes of illustration in order to keep the depiction simple.

As indicated in FIG. 2b, the individual cabin modules 16 through 22 include pre-installed connections 44 (for simplification purposes, such connection is only shown for the cabin module), e.g. for water and electric power, which are provided such that the connections may be coupled upon combination of various cabin modules in a plug-and-play manner. The connections 44 for example, are integrated into the pallets.

While not depicted in the figures, cabin modules which do not require sidewalls may also be provided, and may be disposed between the above mentioned cabin modules. One example of such a cabin module is a table that is pre-installed on a pallet to be disposed in the center of the cabin compartment 1.

While, per the above, the cabin module is described with reference to preferred embodiments, it is to be understood that modifications and variations may be performed without departing from the scope of the invention. For instance, different components than the ones mentioned above may be used and pre-installed onto pallets, e.g. a refrigerator, a table, a toilet, etc.

Alternative combinations and variations of the examples provided will become apparent based on this disclosure. It is not possible to provide specific examples for all of the many possible combinations and variations of the embodiments described, but such combinations and variations may be claims that eventually issue.

Reference Numerals

| | |
|---|---|
| 1 | cabin compartment |
| 2 | cabin compartment |
| 3 | cabin compartment |
| 4 | cabin compartment |
| 5 | cabin compartment |
| 6 | sleeper seat |
| 7 | pallet |
| 8 | window |
| 9 | locker |
| 10 | pallet |
| 11 | door |
| 12 | pallet |
| 13 | sink |
| 14 | pallet |
| 15 a–f | sidewall elements |
| 16 | cabin module |
| 17 | cabin module |
| 18 | cabin module |
| 19 | cabin module |
| 20 | cabin module |
| 21 | cabin module |
| 22 | cabin module |
| 23 | seat |
| 24 | pallet |
| 25 a, b | sidewall elements |
| 26 | pallet |
| 27 | wall panel with window |
| 28 | sidewall |
| 29 | door with window |
| 30 | pallet |
| 31 | locker |
| 32 | sidewall |
| 33 | bed |
| 34 | pallet |
| 35 | sidewall |
| 36 | nightstand |
| 37 | pallet |
| 38 | bed |
| 39 | pallet |
| 40 | sidewall |
| 41 | sink |
| 42 | pallet |
| 43 | sidewall |
| 44 | connections |

What is claimed is:

1. A cabin module comprising:
a pallet, onto which a component is pre-installed, wherein the pallet forms a floor element of a cabin compartment.

2. The cabin module according to claim 1, further comprising
a plurality of pallets, and each of the plurality of the pallets includes a plurality of connections capable of coupling with respective connections of each of the other pallets of the plurality of pallets.

3. The cabin module according to claim 1, wherein the pallet includes at least one fastening element for securing the pallet to a floor structure of a cabin compartment, the at least one fastening element disposed on a bottom side of the pallet, facing away from the component.

4. The cabin module according to claim 3, wherein the at least one fastening element is a quick release fastener for securing the pallet to a seat rail in the floor structure of the cabin compartment.

5. The cabin module according to claim 4, wherein a structure of the quick release fastener transfers a load imparted by the component from the pallet directly into the seat rail.

6. The cabin module according to claim 1, wherein the component is a seat, a bed, a locker, a table, a wall panel, a sink vanity, a door, or a combination thereof.

7. The cabin module according to claim 6, wherein each of a plurality of cabin modules have a structure that is combinable by arranging each of a plurality of pallets for the purpose of forming an internal layout of a cabin compartment.

8. The cabin module according to claim 7, wherein a wall panel is installed onto the plurality of the pallets to form a peripheral wall assembly, after the plurality of the pallets are combined in an arrangement in the cabin compartment.

9. A cabin compartment comprised of a plurality of cabin modules according to claim 1.

10. The cabin compartment according to claim 9 for use in an aircraft, wherein the plurality of the pallets each include connecting structures for attachment to connections in the aircraft.
